(19) United States
(12) Patent Application Publication
(10) Pub. No.: US 2014/0180707 A1
(43) Pub. Date: Jun. 26, 2014

(54) PHARMACEUTICAL INTERACTION CHECKER

(71) Applicant: CVS Pharmacy, Inc., Woonsocket, RI (US)

(72) Inventors: Vijay I. Kukreja, Cumberland, RI (US); Dustin Wayne Humphreys, East Greenwich, RI (US)

(73) Assignee: CVS Pharmacy, Inc., Woonsocket, RI (US)

(21) Appl. No.: 14/132,397

(22) Filed: Dec. 18, 2013

Related U.S. Application Data
(60) Provisional application No. 61/740,924, filed on Dec. 21, 2012.

(51) Int. Cl. G06F 19/00

(52) U.S. Cl. CPC G06F 19/3456
USPC 705/2

(57) ABSTRACT

A smartphone or tablet or in store kiosk application allows a user to input information related to a pharmaceutical product and, in response, displays a list of interactions related to the pharmaceutical product and at least one other product. The application may also check for interactions based on medical conditions.

### CROSS-REFERENCE TO RELATED APPLICATIONS

This application claims priority to and the benefit of U.S. Provisional Patent Application Ser. No. 61/740,924, filed on Dec. 21, 2012, which is hereby incorporated herein by reference in its entirety.

### TECHNICAL FIELD

Embodiments of the current invention generally relate to pharmacy services and, more particularly, to patient monitoring of pharmaceutical intake.

### BACKGROUND

Many different pharmaceutical products exist, and each product may negatively interact with any number of other pharmaceutical products, foods, beverages, and/or beauty products when a person consumes or applies them together. Some combinations of pharmaceutical products may be safe, but may negatively interact with other products or combinations of products. Furthermore, a given combination may be safe for a first person having a first medical history and health profile but unsafe for a second person having a second medical history and health profile. It is difficult for consumers to identify of all the possible side effects produced by simple or complicated combinations of pharmaceutical and other products, especially if their personal medical history and health profile plays a role. For example, while a person may be able to access some pharmaceutical interaction information via the Internet, that information may be from an untrustworthy source, out of date, not tailored to a particular dosage or amount, and/or not customized to a particular person. Furthermore, even if the information is identified, it is difficult for consumers to manage and organize this information. A need therefore exists for an easy-to-use method and application that allows a person to simply and efficiently enter descriptions of one or more pharmaceutical products and that provides that person with reliable, comprehensive, and accurate data regarding any possible negative interactions caused by the products.

### SUMMARY

An application installable on a smartphone, tablet, in-store kiosk, wearable computer (such as a wristwatch or eyeglass-style computer) or other electronic device allows a user of the application to input information identifying two or more pharmaceuticals; the application then presents the user with information regarding any possible interactions between the two or more pharmaceuticals . The identifying information may be input via a text description, an identification number, or a scan of a barcode, voice (speech), QR code, or NFC information printed on or attached to a package containing the pharmaceutical. The application may be a stand-alone application or a sub-application of another application (e.g., a virtual pharmacy application). The pharmaceuticals may be prescription, over-the-counter, or any combination thereof. The interaction information may further be based on the medical or other personal information of the user (e.g., prescription drug list, medical history, or other conditions). Embodiments also provide options for communicating via phone call, chat, email, SMS, push notification, secure inbox, phone number (calling), and/or VOIP with or between the store, pharmacists, or doctors based on the results of any interactions detected and their severity.

In one embodiment, a system for detecting an interaction between a pharmaceutical product and at least one other product includes an input device for receiving information related to a pharmaceutical product, a network interface for sending the information to a remote server and for receiving, in response, interaction information related to the pharmaceutical product, a display for displaying the interaction information to a user.

The input device may be a keyboard, a soft keyboard, a camera, an NFC or voice via microphone or a QR code scanner. The other product may include another pharmaceutical product, a food, a beverage, or a beauty product. The interaction information may be computed at least in part on personal information related to the user. The system may authenticate the user before using the personal information. The personal information may include a sex, age, height, weight, prescription history, or medical history conditions of the user. The display may include inputs for sorting or viewing the interaction information. The interaction information may be sorted by severity. The communication and/or contact information may be displayed.

In another aspect, a system for determining an interaction between a pharmaceutical product and at least one other product includes a network interface for receiving, from a user, information related to at least one pharmaceutical product, a database of interaction information, a database of patient information, a database of store contact information, pharmacists contact information, doctor contact information, and a processor for (i) determining an interaction between the at least one pharmaceutical product and at least one other product in the database and (ii) sending the determined interaction information to the user via the network interface.

The one other product may include another pharmaceutical product, a food, a beverage, or a beauty product. The interaction information may be computed at least in part on personal information related to the user. The user may be authenticated before use of the personal information. The personal information may include a sex, age, height, weight, prescription history, or medical history of the user.

In another aspect, a method for determining an interaction between a pharmaceutical product and at least one other product includes receiving information related to at least one pharmaceutical product, searching, on a database residing on a non-volatile storage medium, for an interaction between the least one pharmaceutical product and at least one other product, and sending information related to the interaction for display on a device.

A user associated with the at least one pharmaceutical product may be authenticated via sign in using a username, email address, finger print, and/or voice authentication. The interaction may be modified based at least in part on personal information associated with the user. The device may be a smartphone, tablet, or personal computer. The information related to at least one pharmaceutical product may be input by a user via a keyboard, soft keyboard, or camera.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a screenshot of a pharmaceutical-interaction checking application;

FIG. 2 is a block diagram of a client system for performing pharmaceutical-interaction checking;

FIG. 3 is a screenshot of a pharmaceutical-interaction checking application illustrating entered pharmaceuticals;

FIG. 4 is a block diagram of a server for performing pharmaceutical-interaction checking;

FIG. 5 is a screenshot of a pharmaceutical-interaction checking application illustrating resultant interactions;

FIG. 6 is a screenshot of a pharmaceutical-interaction checking application illustrating voice-interactive functions;

FIG. 7 is a screenshot of a pharmaceutical-interaction checking application illustrating scanning functions;

FIG. 8 is a screenshot of a pharmaceutical-interaction checking application illustrating quick-response-code functions;

FIGS. 9-11 are screenshots a pharmaceutical-interaction checking application illustrating pharmaceutical selection; and

FIGS. 12 and 13 are screenshots a pharmaceutical-interaction checking application illustrating confirmation functions.

### DETAILED DESCRIPTION

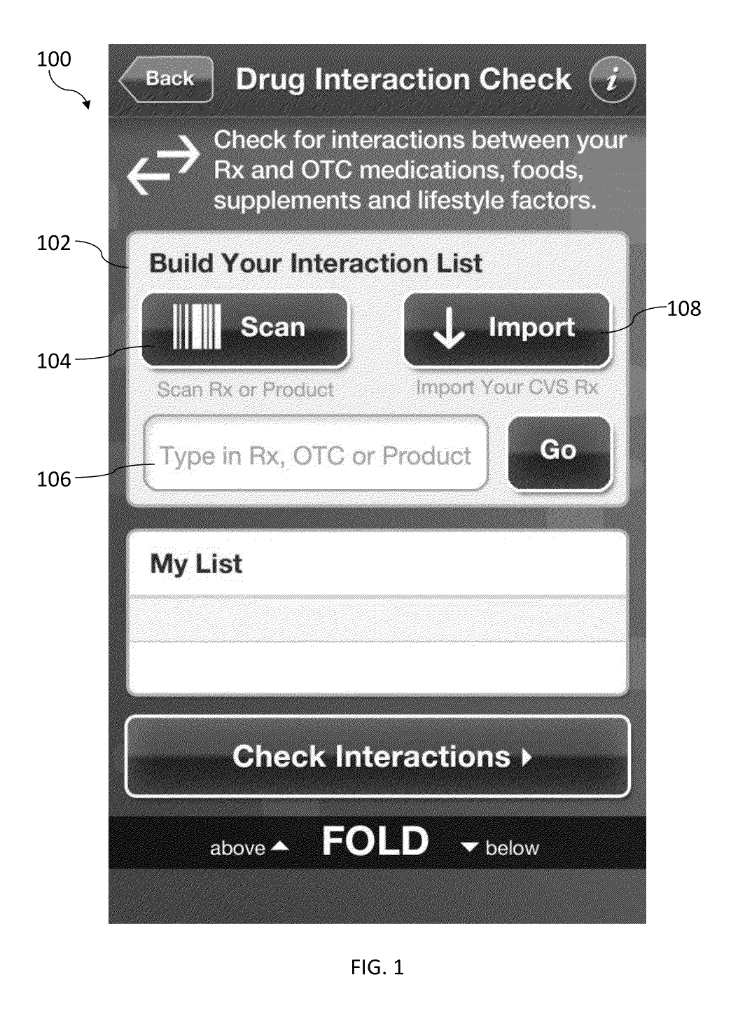

FIG. 1 illustrates an interface 100 with which a user may input one or more pharmaceutical products (e.g., over-the-counter, prescription, or other drug products) and receive information in response that indicates any possible negative interactions between the one or more pharmaceutical products and one or more other pharmaceutical products, foods, beverages, beauty products, or other products. The interface 100 may run on a smartphone, tablet computer, personal computer, notebook computer, personal-digital assistant, or any other similar device. An input portion 102 of the interface 100 allows the user to input information related to a pharmaceutical product via any method known in the art. Such input methods may include a scan function 104 for scanning in a barcode or other code associated with (e.g., printed on) a pharmaceutical product, a text input field 106 with which a user may type in some or all of a name of a pharmaceutical product, and an import function 108 with which a user may import information previously associated with the user (from, e.g., a user account associated with the user). Other methods of input, such as a picture-based search of a photograph of a pharmaceutical package or pill (the photograph taken by, for example, the device running the interface 100), a near-field communication (“NFC”) input from a pharmaceutical package or store display, or a voice-based input, are also within the scope of the present invention.

The barcode or other code to be scanned in may be a universal product code (“UPC”) or other, custom code. The custom code may include additional information related to a pharmaceutical product, such as a prescription number, pharmacy identification number and/or location, drug dosage, number of refills available, or any other such information. The scan input 104, when activated, may detect whether a scanned code is a UPC or custom code, or it may prompt the user to input whether the scanned code is a UPC or custom code. In one embodiment, the scan input 104 may reject a non-standard code that does not conform to a known format. For example, if a user attempts to scan a custom code appearing on a pharmaceutical product issued by a pharmacy owned by a different company, the interface 100 may display a message indicating that the non-standard code is unreadable.

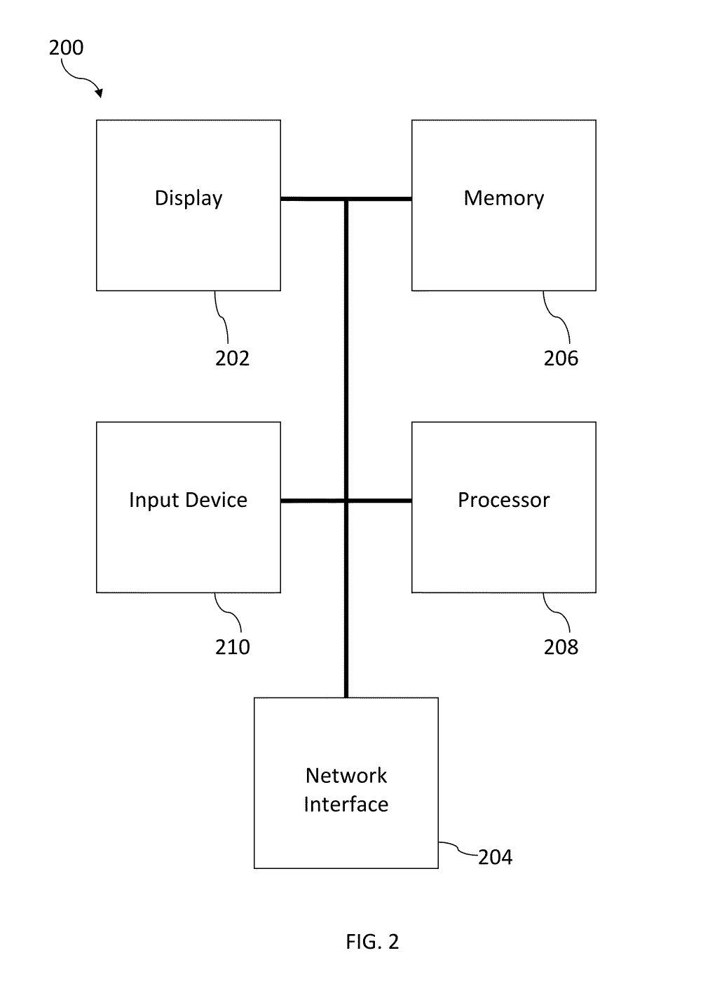

FIG. 2 illustrates a system 200 for running embodiments of the current invention. The interface 100 of FIG. 1 may be displayed on a display 202. Computer instructions (e.g., an application) for creating the interface 100, receiving and interpreting user input, computing interaction results, and communicating with other computers and systems (via a network interface 204) may be stored on a memory 206 and executed on a processor 208. A user input device 210 accepts input from a user. The display 202 may be a smartphone display, tablet display, computer display, or any other such display device. The network interface 204 may be a Wi-Fi interface, ETHERNET interface, USB interface, cellular-phone data interface, or any other such network interface. The memory 206 may be any type of volatile (e.g., RAM) or non-volatile (e.g., ROM, flash, SSD, or hard disk) storage device. The processor 208 may be any general-purpose, digital-signal, ASIC, or other such processor. The input device 210, as stated above, may be a voice input, a camera, and NFC interface, a (hard or soft) keyboard, a touchscreen, or any other such input device. The computer instructions may be loaded onto the system 200 via a market interface associated with the device, via a web link, or by any other such means.

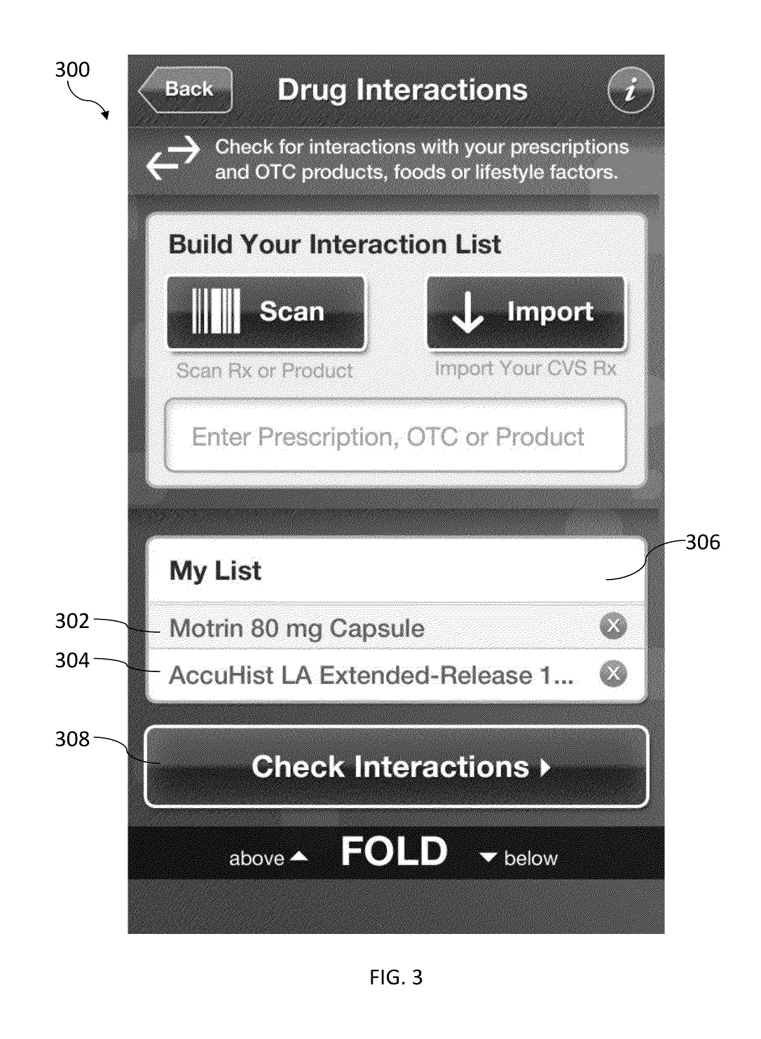

FIG. 3 illustrates an embodiment of an interface 300 in which two pharmaceutical products 302, 304 have been successfully entered and displayed in a status area 306. A user may review, edit, or delete the pharmaceutical products 302, 304 if the user detects any error in their input. Once the user has verified the pharmaceutical products 302, 304, the user may select an input function 308 to check any interactions between the pharmaceutical products 302, 304.

When the interaction-checking function is activated, at least one input pharmaceutical product is compared against a number of potentially interacting products. In one embodiment, a list of potentially interacting products and their possible interactions with the input product is stored locally (on, e.g., the memory 206 in system 200 illustrated in FIG. 2), and the processor 208 searches the memory 206 for potential interactions. In another embodiment, the system 200 communicates with a remote server (via, for example, the network interface 204), and the remote server performs the interaction checking.

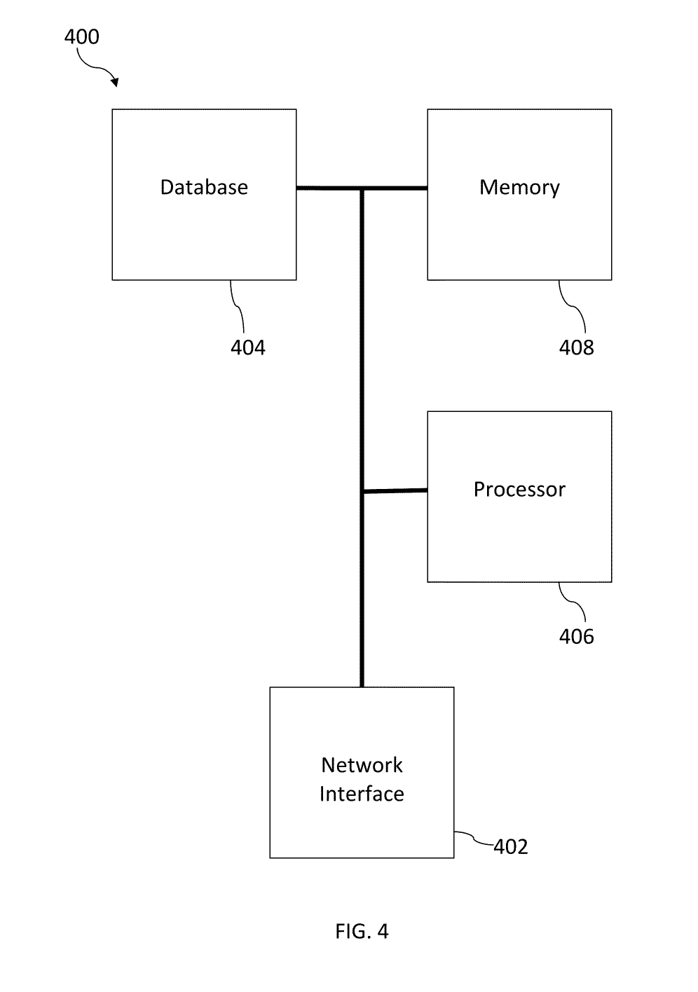

One embodiment of such a server 400 is illustrated in FIG. 4. The server 400 receives relevant information from the user application 200 via a network interface 402 over a network link such as the Internet. The relevant information may include the user-input pharmaceutical product(s), other product(s), or personal information related to the user (as explained in greater detail below). The server 400 may access a database 404 of interaction and/or user/patient information that may include pharmaceutical information, medical information, or other such information. In one embodiment, the server 400 locates the user-input data (and any other prescription or pharmaceutical data in an account related to the user) and locates any drugs related to the user-input data in the database 404. The server 400 runs a comparison of the located drug(s) against the information in the database 404 and, if there is a match indicating known interactions between the located drug, the drugs in the user account, or any other drugs, the server 400 compiles the interactions in a list (for communication to the user). If there are no known interactions, that information may be communicated to the user as well. The database 404 may be any non-volatile storage medium, such as a hard or solid-state disk drive, array of drives, cloud storage, or any other such medium. A processor 406 may compare the user-input information against information in the database 404 (using, in one embodiment, non-volatile memory 408 to store data) and generate a list of potential interactions. These potential interactions may then be sent (again, using the network interface 402) back to the application 200 for display to the user.

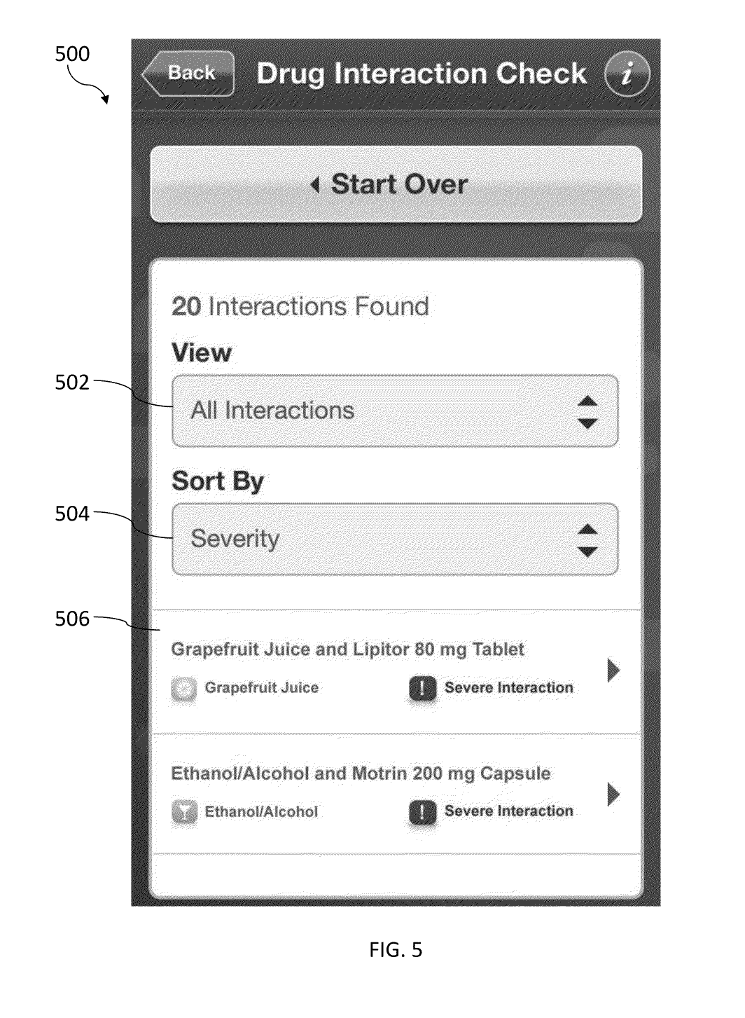

FIG. 5 illustrates a result screen 500, displayable on the display 202 of FIG. 2, that indicates any potential interactions between input pharmaceutical product(s). The user may select how many interactions are viewed using a first input tool 502 and may sort the results by severity using a second input tool 504. In this embodiment, the input tools 502, 504 are pop-up menus, but any method of selection is within the scope of the current invention.

The list of the interactions is shown in an output area 506. Each item in the list 506 may include the interacting products or items in textual or iconic form along with, in some embodiments, images of the drugs and products and an indication of the severity of the interaction. In one embodiment, severe interactions are highlighted using bright colors, an exclamation-point icon, or other such highlighting. The user may select each item in the list 506 to receive further information about each interaction (as indicated by, for example, an arrow icon).

In one embodiment, the identity of the user is not known to the system 200, and the interaction information is based solely on the interactions between the product(s). In another embodiment, the user identity is known to the system, and the medical history and health profile of the user is used to improve the interaction information. For example, the user may have other currently active prescriptions that may interact with an entered pharmaceutical product; in one embodiment, recently terminated prescriptions that may still have long-term effects on the user are also considered. Other general information about the user (e.g., sex, age, height, weight, or other such factors) may be considered, as well as health information (e.g., high blood pressure, anemia, or other such factors).

The user may enter his or her medical history and health profile information via the system 200; in one embodiment, the user has a pre-existing account containing some or all of this information. The user may access their pre-existing information via an authentication process (e.g., by inputting a user name and password). Once authenticated, the system 200 may automatically incorporate the stored medical history and health profile information into the interaction results 506.

In other embodiments, the system 200 may also be used for other functions. For example, a user may refill a prescription of a pharmaceutical product scanned in by the scan input 104 shown in FIG. 1. In one embodiment, the user need not authenticate him or herself to the system 200 in order to refill a prescription. The display 202 may indicate a number of refills available. In another example, the system 200 may locate a nearby pharmacy at which the user may pick up a prescription; the system 200 may offer the name and location of a pharmacy previously associated with the user and/or a pharmacy near to the user. The location of the user may be determined by any method known in the art (e.g., GPS services, Wi-Fi access, or cellphone tower triangulation).

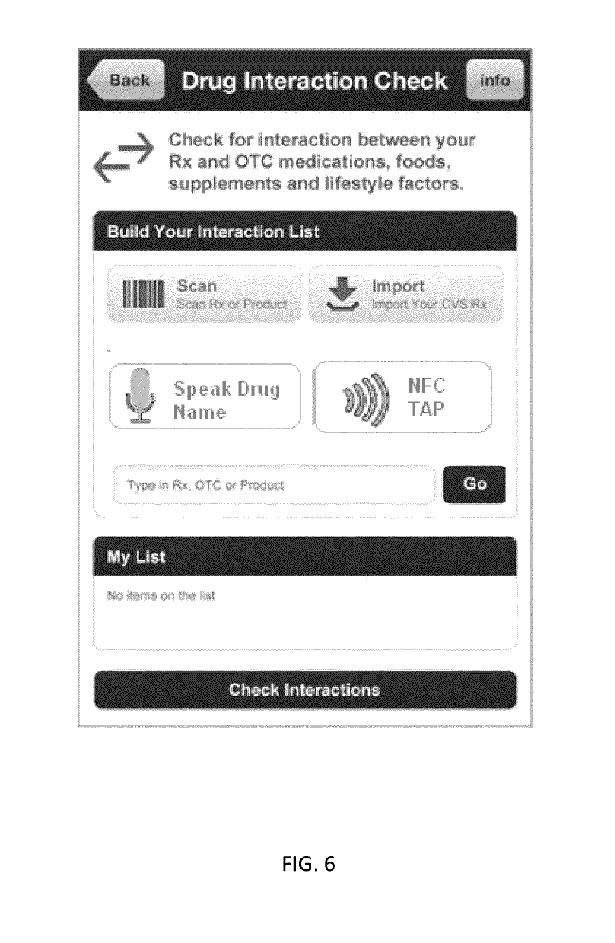

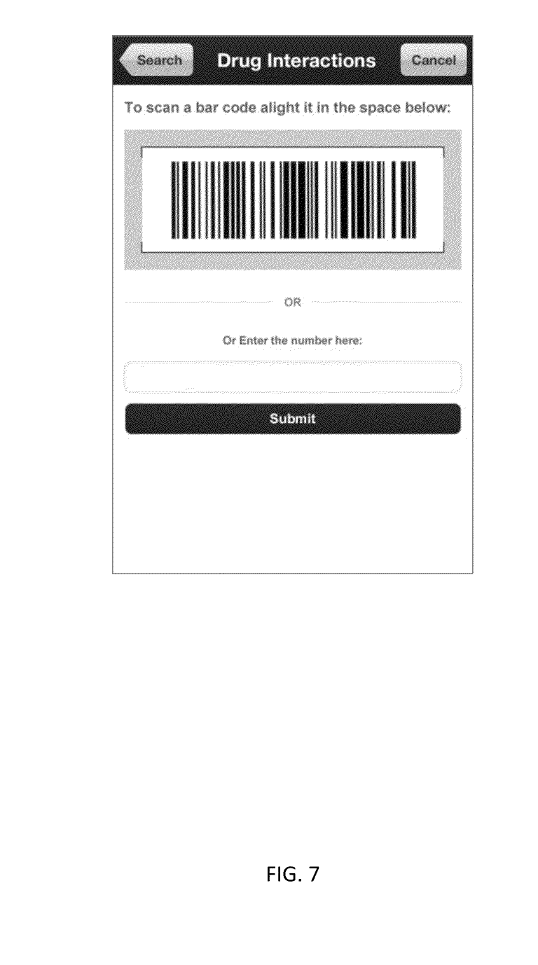

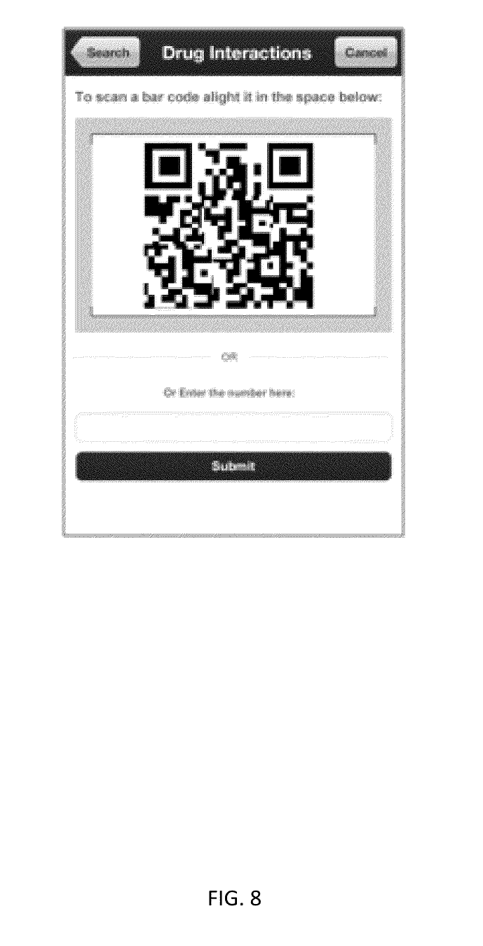

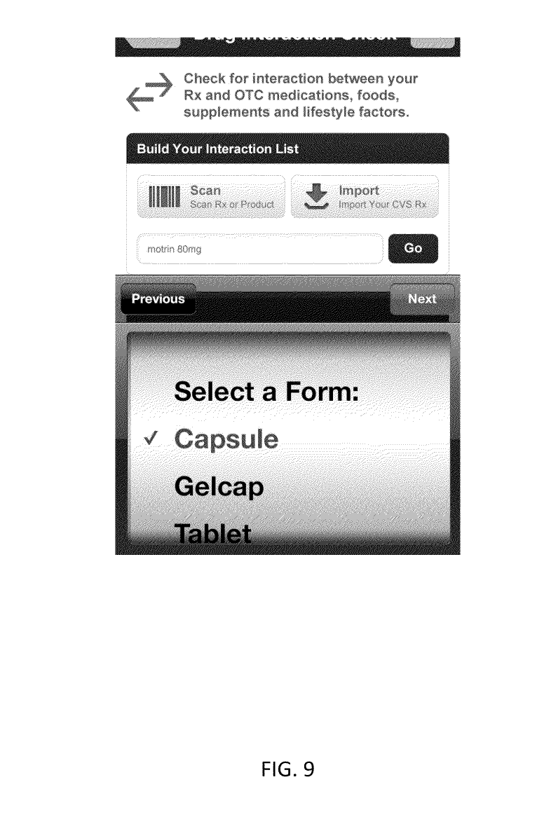

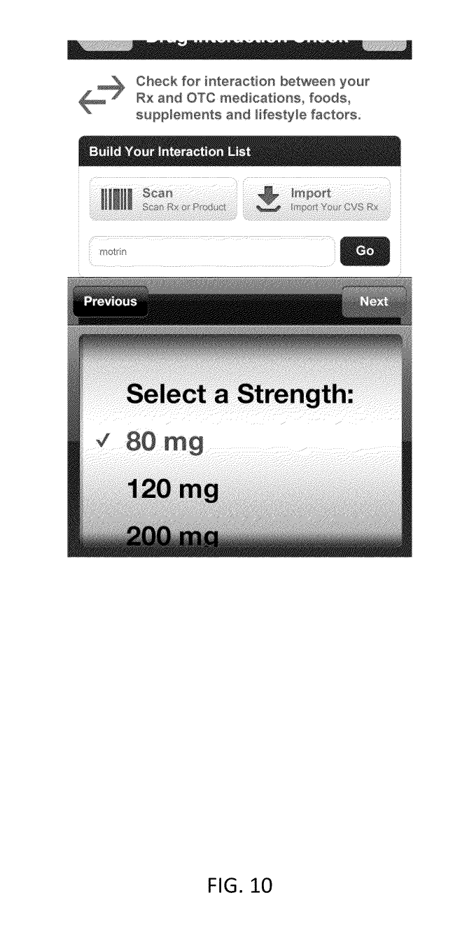

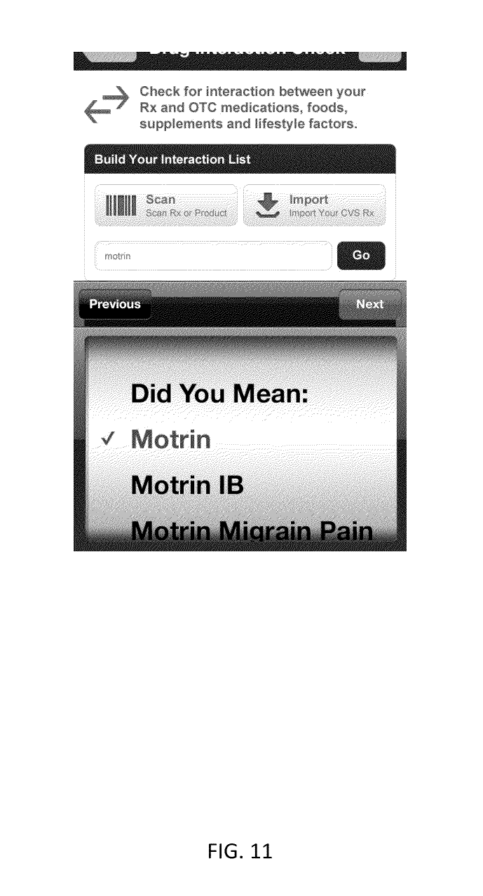

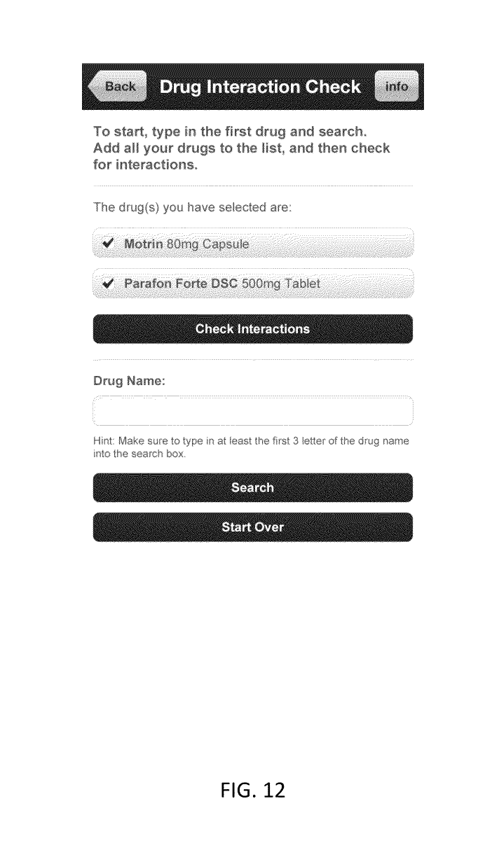

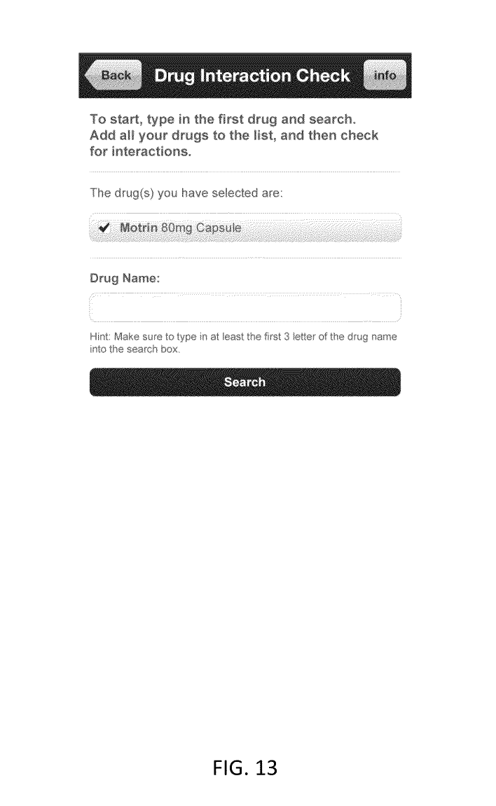

FIGS. 6-8 illustrate different ways of entering pharmaceutical information. In FIG. 6, a user may select an option to speak the name of a drug; the user's voice response is analyzed and, if the resultant analysis indicates that the user spoke the name of a drug, that drug is recognized as an input for interaction checking. The user may also select a function for NFC communication (if the user's phone and input object (e.g., a pharmaceutical package) are compatible with NFC communication. In FIG. 7, a user may scan a bar code associated with a pharmaceutical or enter a number associated with the pharmaceutical; similarly, as shown in FIG. 8, a user may scan a quick-response (“QR”) code associated with a pharmaceutical. FIGS. 9-11 illustrate an exemplary interface with which a user may specify a drug delivery type, drug strength, and clarify a drug name or type. FIGS. 12 and 13 illustrate exemplary interfaces with which a user may verify that the system correctly identified an input drug.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for detecting an interaction between a pharmaceutical product and at least one other product, the system comprising:
an input device for receiving information related to a pharmaceutical product;
a network interface for sending the information to a remote server and for receiving, in response, interaction information related to the pharmaceutical product; and
a display for displaying the interaction information to a user.

2. The system of claim 1, wherein the input device comprises a keyboard, soft keyboard, camera, NFC scanner, voice scanner, or QR code scanner.

3. The system of claim 1, wherein the at least one other product comprises another pharmaceutical product, a food, a beverage, or a beauty product.

4. The system of claim 1, wherein the interaction information is computed at least in part on personal information related to the user.

5. The system of claim 4, wherein the system authenticates the user before using the personal information.

6. The system of claim 4, wherein the personal information comprises a sex, age, height, weight, prescription history, or medical history, conditions of the user.

7. The system of claim 1, wherein the display comprises inputs for sorting or viewing the interaction information.

8. The system of claim 1, wherein the interaction information is sorted by severity.

9. The system of claim 1, wherein the communication and/or contact information is displayed.

10. A system for determining an interaction between a pharmaceutical product and at least one other product, the system comprising:
a network interface for receiving, from a user, information related to at least one pharmaceutical product;
a database of interaction information;
a database of patient information;
a database of store contact information, pharmacists contact information, doctor contact information; and
a processor for (i) determining an interaction between the at least one pharmaceutical product and at least one other product in the database and (ii) sending the determined interaction information to the user via the network interface.

11. The system of claim 10, wherein the at least one other product comprises another pharmaceutical product, a food, a beverage, or a beauty product.

12. The system of claim 10, wherein the interaction information is computed at least in part on personal information related to the user.

13. The system of claim 12, wherein the user is authenticated before use of the personal information.

14. The system of claim 12, wherein the personal information comprises a sex, age, height, weight, prescription history, or medical history of the user.

15. A method for determining an interaction between a pharmaceutical product and at least one other product, the method comprising:
receiving information related to at least one pharmaceutical product;
searching, on a database residing on a non-volatile storage medium, for an interaction between the least one pharmaceutical product and at least one other product; and
sending information related to the interaction for display on a device.

16. The method of claim 15, further comprising authenticating, via sign-in using a username, email address, finger print, and/or voice authentication, a user associated with the at least one pharmaceutical product.

17. The method of claim 16, further comprising modifying the interaction based at least in part on personal information associated with the user.

18. The method of claim 15, wherein the device is a smartphone, tablet, or personal computer.

19. The method of claim 15, wherein the information related to at least one pharmaceutical product is input by a user via a keyboard, soft keyboard, camera, NFC scanner, voice scanner, or QR code scanner.
